(19) United States
(12) Patent Application Publication
(10) Pub. No.: US 2008/0038135 A1
(43) Pub. Date: Feb. 14, 2008

(54) CORROSION RESISTANT HYDRAULIC MOTOR

(75) Inventors: Richard Daigre, Hopkinsville, KY (US); Tyrel Menser, St. Charles, KY (US)

Correspondence Address: FAY SHARPE LLP, 1100 SUPERIOR AVENUE, SEVENTH FLOOR, CLEVELAND, OH, 44114, US

(73) Assignee: WHITE DRIVE PRODUCTS, INC., Hopkinsville, KY (US)

(21) Appl. No.: 11/463,681

(22) Filed: Aug. 10, 2006

(51) Int. Cl. F01C 1/02; F01C 1/063; F03C 2/00

(52) U.S. Cl. 418/61.3

(57) ABSTRACT

A corrosion resistant hydraulic motor includes a housing, an output shaft extending through an opening in the housing, a sealing member contacting the output shaft and a water proof coating disposed on an exterior surface of the housing and on the sealing member. The sealing member is configured to cooperate with the output shaft to preclude corrosive material from passing through the opening into an internal compartment of the motor.

### BACKGROUND

Hydraulic motors are prone to rust and/or corrosion when used in corrosive enviroments such as salt and sand spreaders, marine applications, swimming pools, ect. To combat against rust and corrosion, hydraulic motor manufactures paint, epoxy coat, powder coat or electroless nickel coat hydraulic motors.

Current coatings and treatments are not totally effective against prohibiting rust and corrosion. For example, paint and epoxy type coatings chip and then flake off. Moreover, transition points, e.g. points between different components and/or different materials of the hydraulic motor, allow infiltration under the paint type coatings, which results in the coating flaking off. Electroless nickel is expensive and will still allow rusting on porous cast surfaces.

To avoid the problems associated with known coatings, those skilled in the art have attempted to isolate the hydraulic motor from the corrosive enviroment. For example, where hydraulic motors have been used to move water in swimming pools, the motor has been placed in a sealed chamber where the output shaft of the motor extends from the sealed chamber. Hydraulic oil or another lubricant is then placed in the sealed chamber to further protect the motor. This assemlby, however, is prone to leak.

### SUMMARY OF THE INVENTION

A method for providing a corrosion resisting barrier to a hydraulic motor includes the following steps: applying a corrosion resistant coating to an outer surface of a housing of the hydraulic motor such that substantially the entire outer surface is covered with the coating; and sealing an opening through which an output shaft of the hydraulic motor extends in a manner that allows the output shaft to rotate while inhibiting infiltration of corrosive material through the opening into the hydraulic motor.

A corrosion resistant hydraulic motor includes a housing, an output shaft extending through an opening in the housing, a sealing member contacting the output shaft and a water proof coating disposed on an exterior surface of the housing and on the sealing member. The sealing member is configured to cooperate with the output shaft to preclude corrosive material from passing through the opening into an internal compartment of the motor.

### BRIEF DESCRIPTION OF THE DRAWINGS

FIG. 1 is a sectional view of a hydraulic motor incorporating a corrosion resistant system.

### DETAILED DESCRIPTION

An example of a hydraulic motor 10 that is resistant to rust and corrosion will be described in detail below. The components of the motor 10 are more fully described in pending U.S. patent application Ser. No. 11/382,171, entitled Gerotor Motor and Brake Assembly, which is incorporated by reference herein in its entirety. The corrosion resistant coating and/or system that is described below can be used with other types of hydraulic motors and devices, and is not limited to be used with only the motor 10 that is described below.

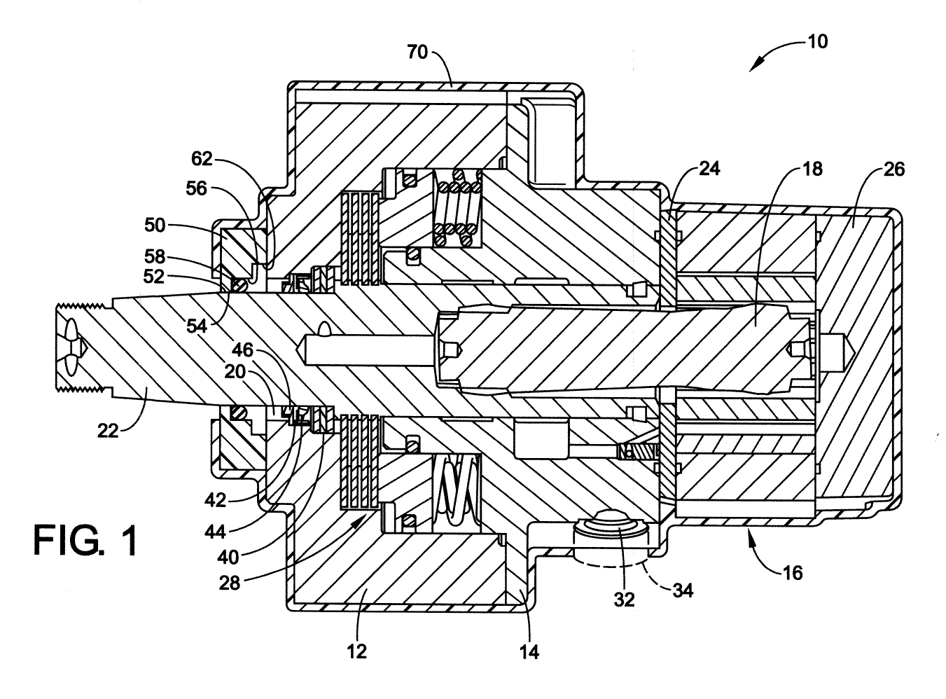

With reference to FIG. 1, the hydraulic device 10, which can also operate as a pump in a manner that is known in the art, includes a housing assembly that includes a front housing section 12 and a rear housing section 14. The housing sections attach to one another via bolts (not shown) received in bolt holes (not shown) formed in the housing sections.

A gerotor assembly 16 connects to the rear housing section 14. In the depicted embodiment, the rotor assembly 16 is similar to a known gerotor assembly that includes a stator and a rotor, accordingly further description is not provided.

A wobble stick 18, also referred to as a drive link or a wobble shaft, connects to the rotor of the gerotor assembly 16 in a known manner. The wobble stick 18 connects to an output shaft 22, also in a known manner. Since the motor 10 is designed to be used in a corrosive environment, the outer surface of the output shaft 22 can be electroless nickel coated.

A wear plate 24 is sandwiched between the rear housing section 14 and the rotor assembly 26, The wear plate 24 includes a plurality of openings (not visible) radially spaced from a rotational axis of the output shaft 22. The openings in the wear plate 24 communicate with the cells (either expanding or contracting) formed in the rotor assembly in a manner that is known in the art

An end plate 26 attaches to the gerotor assembly 16 on an opposite side of the gerotor assembly as the wear plate 24. In the depicted embodiment, the end plate 26 closes the housing assembly for the moveable components of the hydraulic motor.

When operating as a motor, rotation of the output shaft 22 is caused by delivering pressurized fluid to the expanding cells of the gerotor assembly 16. The hydraulic motor 10 can also operate as a pump when the output shaft 22 is driven by an external power device, for example a gasoline or diesel engine.

The hydraulic motor 10 also includes a brake assembly 28 that acts to restrict rotation of the output shaft 22. The brake assembly 28 is more fully described in U.S. patent application Ser. No. 11/382,171.

In the hydraulic motor 10 depicted in FIG. 1, two ports, only one port 32 is shown in FIG. 1, allow for the ingress and egress of hydraulic fluid. A fitting 34 (two fittings are provided, one for each port) connects in the first port 32 to allow for the connection of a fluid hose to the motor 10. In the depicted embodiment, the fitting 34 is a known corrosion resistant fitting such as stainless steel, zinc dichromate or a yellow dichromate fitting. The fluid hoses are connected to a pressure source, in the case where the hydraulic motor is used to deliver power to the output shaft 22, or to a hydraulic device that is to receive pressurized fluid, in the case where the hydraulic motor is used as a pump.

A thrust bearing assembly 40, which in the depicted embodiment includes two washers having a thrust bearing sandwiched between them, surrounds the output shaft 22. A seal retainer 42 that retains a seal 44 fits around the output shaft outside of the thrust bearing assembly 40. A seal support 46 and dust cover fits around the output shaft 22 to protect the seal 44 and other internal components. The seal 44 cooperates with the front housing section 12, the seal retainer 42 and the output shaft 22 to define a boundary for the hydraulic fluid moving through the motor.

A flange 50 attaches to the front of the front housing section 12 via conventional fasteners (or similar mechanical attachment). The flange 50 is similar to a flange that is used with a speed sensor assembly that is more fully described in U.S. patent application Ser. No. 10/474,110, entitled Speed sensor flange assemblies, which is incorporated by reference herein.

In the depicted embodiment, the flange is made of plastic, for example an acetal; however, the flange can be made from another material that does not easily corrode in an aqueous environment. The flange 50 includes a central through-bore 52 that is dimensioned to snugly receive the output shaft 22, More particular to the depicted embodiment, the flange 50 includes a shoulder 54 that contacts the peripheral surface of the output shaft 22. The flange also includes a central counter bore 56 that receives a seal 58 and a rear counter bore 62 that is greater in diameter than the central counterbore.

The shoulder 54 and the seal 58 protect the internal components of the hydraulic motor 10, in addition to the seal 44, dust cover 46 and seal retainer 44 that are disposed in the front housing section 12. If desired, the counter bores 56 and 62 can be filled with a lubricant, e.g. oil, to further protect the internal components of the hydraulic motor. In such an instance, the flange 50 may include an additional opening through which the lubricant can be introduced.

The hydraulic motor 10 includes a corrosion resistant coating 70 that in combination with the flange 50 and seals 44 and 58 protects the motor so that it can be used in a corrosive environment. The flange 50 can act as a sealing member to inhibit the infiltration of corrosive material into the internal compartments of the hydraulic motor. The corrosion resistant coating 70 can be a polyurethane material, an aliphatic polyurea elastomer, or a similar waterproof material, that is sprayed onto the housing sections 12, 14, 16, 24 and 26 of the motor 10 after the motor has been assembled. If desired, the motor 10 can be dipped into a tank containing the corrosion resistant material. In either case, the output shaft 22 and a portion of each fitting 34 are masked so that the coating does not adhere to these components.

The corrosion resistant coating adheres to the housing sections to form a protective barrier so that air and moisture cannot penetrate to the metal housing sections. The corrosion resistant coating 70 can be applied between about ⅛″ to about ½″ inches thick, preferably about ¼″ inches thick. The corrosion resistant coating 70 can provide a continuous coating between adjoining components of the motor 10 (see, for example, where the front housing section 12 contacts the rear housing section 14).

The corrosion resistant system incorporates the plastic (or other non-corrosive material) flange 50 in conjunction with the corrosion resistant coating 70. The flange can also be plastic coated or coated with a non-corrosive material. The corrosion resistant coating 70 coats a part of the flange 50 in addition to the remainder of the external surface of the metal components 12, 14, 16, 24 and 26 of the motor 10. By coating a portion of the flange 50, no metal portion of the motor 10 (except for the fittings 34 which will be described in more detail below) is exposed. The plastic flange 50 provides a large surface area for the corrosion resistant coating 70 to adhere to. Use of the plastic flange 50 also allows for the shoulder 54, the seal 58 and any fluid that is trapped by the flange to further protect the motor 50. Alternatively, the front surface of the front section 12 (the surface that abuts the flange 50 in FIG. 1) can be coated up to the opening that the output shaft 22 extends through and the seal support 46 and the seal 44 that are disposed in the front section 12 can be used to protect the internal components of the motor 10.

The fittings 34 are installed prior to coating the motor. Outer portions, (with respect to the rear housing section 14) are masked prior to coating. Accordingly, when the coating 70 is applied, the fittings 34 are partially coated. The joint or transition point between the motor port 32 and the standard available corrosion resistant fittings 34 are totally coated eliminating (or greatly reducing) the likelihood of corrosion at the transition point between the motor and the corrosion resistant fitting. A connection between the fitting 34 and a fluid supply hose (not shown) is still possible after the motor has been coated.

A corrosion resistant hydraulic motor has been described. Modifications and alterations will occur to those upon reading and understanding the preceding detailed description. The invention is not limited to only the embodiments disclosed above. Instead, the invention is broadly defined by the appended claims and the equivalents thereof.

1. A hydraulic device comprising:
a metal housing;
an output shaft disposed in the housing and including a portion extending from the housing;
a gerotor assembly operatively connected to the output shaft;
a non-metallic flange attached to the housing and receiving the output shaft; and
a corrosion resistant coating disposed over the housing and continuing over the flange.

2. The device of claim 1, wherein the flange contacts the output shaft.

3. The device of claim 1, further comprising a seal contacting the flange and the output shaft.

4. The device of claim 1, wherein the corrosion resistant coating comprises at least one of a polyurethane material and an aliphatic polyurea elastomer.

5. The device of claim 1, wherein the housing comprises at least two components that abut one another to generally define a contact surface and the corrosion resistant material bridges over the contact surface.

6. The device of claim 1, wherein the output shaft is electroless nickel coated.

7. The device of claim 1, wherein the housing define a port that is in fluid communication with the gerotor assembly, the device further comprising a fitting connected with the port, wherein the coating is disposed over a portion of the fitting such that an associated fluid hose can attach to the fitting.

8. A method for providing a corrosion resisting barrier to a hydraulic motor, the method comprising:
applying a corrosion resistant coating to an outer surface of a housing of the hydraulic motor such that substantially the entire outer surface is covered with the coating; and
sealing an opening through which an output shaft of the hydraulic motor extends in a manner that allows the output shaft to rotate while inhibiting infiltration of corrosive material through the opening into the hydraulic motor.

9. The method of claim 8, wherein the sealing step includes attaching a plastic flange to the housing adjacent the output shaft.

10. The method of claim 9, wherein the attaching step includes attaching the plastic flange to the housing such that the output shaft is received in an opening of the flange.

11. The method of claim 10, wherein the applying step comprises applying the corrosion resistant coating to the plastic flange.

12. The method of claim 8, wherein the applying step includes spraying the corrosion resistant coating onto the outer surface of the housing.

13. The method of claim 8, further comprising attaching a fitting to a port of the hydraulic motor and the applying step comprises applying the corrosion resistant coating to the fitting.

14. The method of claim 13, wherein the applying step comprises applying the corrosion resistant coating to the fitting in a manner such that a hydraulic hose can attach to the fitting without interfering with the corrosion resistant coating.

15. A hydraulic motor comprising a housing, an output shaft extending through an opening in the housing, a sealing member contacting the output shaft and a waterproof coating disposed on an exterior surface of the housing and on the sealing member, the sealing member being configured to cooperate with the output shaft to preclude corrosive material from passing through the opening into an internal compartment of the motor.

16. The hydraulic motor of claim 15, wherein the sealing member comprises a flange comprising a corrosion resistant material attached to the housing.

17. The hydraulic motor of claim 17, wherein the sealing member includes a seal that contacts the plastic flange and the output shaft.

18. The hydraulic motor of claim 15, wherein the housing defines ports, the device further comprising fittings connected with the ports, wherein the coating is disposed over a portion of the fitting such that an associated fluid hose can attach to the fittings.

19. The hydraulic motor of claim 15, wherein the waterproof coating extends from the housing greater than about ⅛″.
